(19) United States
(12) Patent Application Publication
(10) Pub. No.: US 2026/0360786 A1
(43) Pub. Date: Nov. 12, 2026

(54) THIN FLAT PLANAR SOLID OXIDE CELL, METHOD OF MANUFACTURE THEREOF AND ACCELERATED TEST PROTOCOLS FOR THE SAME

(71) Applicant: UNIVERSITY OF CONNECTICUT, Farmington, CT (US)

(72) Inventors: Xiao-Dong Zhou, Columbia, CT (US); Nengneng Xu, Vernon, CT (US); Yudong Wang, Willimantic, CT (US)

(21) Appl. No.: 19/673,336

(22) Filed: May 11, 2026

Related U.S. Application Data
(60) Provisional application No. 63/802,868, filed on May 9, 2025.
(60) Provisional application No. 63/802,874, filed on May 9, 2025.

(51) Int. Cl. H01M 8/1226; C25B 9/19; C25B 11/047; C25B 13/07; H01M 4/90; H01M 8/12

(52) U.S. Cl. CPC H01M 8/1226; C25B 9/19; C25B 11/047; C25B 13/07; H01M 4/9025; H01M 2008/1293

(57) ABSTRACT

A solid oxide cell includes an electrolyte, an anode disposed on a first surface of the electrolyte, a cathode disposed on a second surface of the electrolyte opposite the first surface. A stress compensation layer disposed on a surface of the anode or the cathode opposite the electrolyte. The stress compensation layer is configured to reduce warping of the solid oxide cell during sintering or thermal cycling.

### CROSS-REFERENCE TO RELATED APPLICATIONS

This application claims priority to U.S. Provisional Application No. 63/802,868 filed on May 9, 2025 and to U.S. Provisional Application No. 63/802,874 filed on May 9, 2025, the entire contents of which are hereby incorporated by reference.

### STATEMENT REGARDING FEDERALLY SPONSORED RESEARCH

This invention was made with government support under DE-AR0001774 and DE-FE0032110 awarded by the U.S. Department of Energy. The government has certain rights in the invention.

### BACKGROUND OF THE INVENTION

### 1. Field of the Invention

The disclosure relates to a thin flat planar solid oxide cell and to a method of manufacture thereof. It also relates to accelerated test protocols for solid oxide cells

### 2. Description of the Related Art

Solid oxide cells (SOC) such as solid oxide fuel cells (SOFC) or solid oxide electrolysis cells (SOEC) are high-efficiency electrochemical energy conversion devices that operate at elevated temperatures and are capable of directly converting chemical energy from fuels such as hydrogen or syngas into electrical power. A desirable feature for reliable SOC performance is the structural integrity and dimensional stability of the ceramic cell components, including the anode, cathode, and electrolyte layers. In particular, maintaining flatness of the SOC, particularly a SOFC during fabrication and operation ensures uniform sealing, thermal stability, and electrochemical performance across the cell surface.

However, ceramic materials inherently experience shrinkage, warping, or curvature during high-temperature sintering (which occurs at temperatures of 1000 °C to 1500 °C) and thermal cycling (which occurs at temperatures of 600 °C to 900 °C), which often leads to dimensional distortion in the final cell geometry. Non-flat cells can cause mechanical stresses during stack assembly, poor interfacial contact between layers, sealing challenges, and non-uniform current or gas distribution, all of which can compromise the performance and durability of the fuel cell stack.

The current state-of-the-art approach to mitigating cell warping involves applying a physical weight or mechanical load on top of the green or partially sintered ceramic layers during the thermal treatment process to flatten the structure. While this method may achieve temporary flatness, it introduces several drawbacks. The application of external weight can lead to uneven pressure distribution, mechanical defects, or constrained sintering behavior, which may negatively affect the microstructure and electrochemical properties of the cell. Additionally, this approach lacks scalability and reproducibility in large-scale manufacturing, and it does not provide active control over flatness during dynamic fabrication processes.

Solid oxide electrolysis cells (SOECs) like SOFCs also suffer from the effects of being exposed to high temperatures. SOECs are high-temperature electrochemical devices that offer efficient pathways for hydrogen production, carbon dioxide reduction, and other power-to-gas applications by electrolyzing steam and/or carbon dioxide. SOECs operate at elevated temperatures of 600 to 900 °C, and comprise ceramic materials, including oxygen-ion conducting electrolytes (e.g., yttria-stabilized zirconia), porous electrodes, and interconnect materials. While SOECs are known for their high efficiency and scalability, a key challenge in their commercial adoption is their limited long-term durability under aggressive operating conditions.

Degradation mechanisms in SOECs are complex and can involve thermal cycling, electrode delamination, chromium poisoning, redox instability, and microstructural changes, among others. These failure modes generally develop over extended timeframes, often involving thousands of hours of continuous testing to observe meaningful performance decline.

Consequently, evaluating the lifetime and degradation kinetics of SOECs is both time-consuming and resource-intensive, impeding rapid material screening, device qualification and system optimization.

Existing approaches to lifetime testing rely on steady-state or step-change load cycling under nominal operating conditions. These methods are insufficient for accelerated aging studies, as they fail to simulate worst-case degradation pathways or compress the degradation timeline in a controlled and quantifiable manner. Furthermore, there remains a lack of standardized protocols that reliably induce reproducible failure signatures within a short testing window while maintaining relevance to real-world degradation phenomena.

Accordingly, there exists a need for an accelerated degradation protocol that enables reliable prediction of SOEC lifetime over shortened time periods. Such a protocol would serve as a useful tool for rapid evaluation of materials, stack configurations, and protective strategies, and would significantly expedite research and development cycles for next-generation electrolysis technologies. There also remains a need for improved methods or structures that enable the fabrication of dimensionally stable, flat SOFCs without relying on externally applied mechanical weight. Such methods would enhance manufacturability, improve cell reliability, and support scalable production of high-performance solid oxide fuel cells.

### SUMMARY OF THE INVENTION

In an embodiment, a solid oxide cell is provided that includes an electrolyte, an anode disposed on a first surface of the electrolyte, a cathode disposed on a second surface of the electrolyte opposite the first surface. A stress compensation layer disposed on a surface of the anode or the cathode opposite the electrolyte. The stress compensation layer is configured to reduce warping of the solid oxide cell during sintering or thermal cycling.

In another embodiment, a method of manufacturing a solid oxide cell is provided that includes forming a multilayer ceramic body comprising an anode, an electrolyte, and a cathode, applying a stress compensation layer to a surface of the anode, the cathode, or to both the anode and the cathode, and sintering the multilayer ceramic body and the stress compensation layer together to reduce curvature generated during thermal processing.

In yet another embodiment, a method of using a solid oxide cell is provided that includes supplying a fuel to an anode of the solid oxide cell, supplying an oxidant to a cathode of the solid oxide cell, migrating oxygen ions through an electrolyte disposed between the anode and the cathode, and reducing thermally induced warping of the solid oxide cell during operation by using a stress compensation layer disposed on a surface of the anode or the cathode opposite the electrolyte.

In one embodiment, the stress compensation layer comprises a same composition as the electrolyte. In another embodiment, the electrolyte comprises yttria-stabilized zirconia, scandia-stabilized zirconia, gadolinium-doped ceria, samarium-doped ceria, lanthanum strontium magnesium gallate, stabilized bismuth oxide, a proton-conducting ceramic, or a combination thereof. In an embodiment, the stress compensation layer possesses a thickness that is 10% to 100% of a thickness of the anode or the cathode upon which the stress compensation layer is disposed. In one embodiment, the stress compensation layer and the electrolyte possess substantially identical thicknesses and are symmetrically positioned on opposing sides of the anode. In another embodiment, the stress compensation layer covers 20% to 100% of a surface area of the anode or the cathode. In an embodiment, the stress compensation layer includes one or more openings configured to facilitate reactant gas transport to the anode or the cathode. In one embodiment, the one or more openings comprise circular openings, polygonal openings, square openings, triangular openings, concentric openings, or combinations thereof. In another embodiment, the stress compensation layer comprises a ceramic material configured to offset a stress vector generated during sintering of the solid oxide cell. In an embodiment, the solid oxide cell possesses a total flatness deviation of less than or equal to 1 mm across a largest lateral dimension of the solid oxide cell after sintering. In one embodiment, the solid oxide cell possesses a maximum out-of-plane deviation less than or equal to 0.5% of a largest lateral dimension of the solid oxide cell after sintering. In another embodiment, the anode comprises nickel-yttria stabilized zirconia, nickel-gadolinium doped ceria, nickel-samarium doped ceria, a copper-ceria composite, a cobalt-containing cermet, a titanate-based material, a chromite-based material, or a combination thereof. In an embodiment, the cathode comprises lanthanum strontium manganite, lanthanum strontium cobalt oxide, lanthanum strontium cobalt ferrite, samarium strontium cobalt oxide, barium strontium cobalt ferrite, gadolinium-doped ceria, or a combination thereof. In one embodiment, the electrolyte and the stress compensation layer both comprise yttria-stabilized zirconia, the anode comprises a nickel-cermet, the cathode comprises samarium strontium cobalt oxide-gadolinium-doped ceria, the stress compensation layer and the electrolyte possess substantially identical thicknesses and are symmetrically positioned on opposing sides of the anode, the cathode or both the anode and cathode, and the stress compensation layer includes one or more openings configured to facilitate reactant gas transport to the anode or the cathode.

In another embodiment, the solid oxide cell is configured as a solid oxide fuel cell, a solid oxide electrolysis cell, or a reversible solid oxide cell. In an embodiment, applying the stress compensation layer comprises tape casting, screen printing, slurry casting, isostatic pressing, chemical vapor deposition, or a combination thereof. In one embodiment, the sintering is conducted at a temperature of 800 °C to 1600 °C. In another embodiment, the method further comprises forming one or more openings in the stress compensation layer to facilitate gas transport to the anode, cathode or to both the anode and cathode.

A solid oxide cell testing system includes a solid oxide electrolysis cell having a fuel electrode, an oxygen electrode, and an electrolyte disposed between the fuel electrode and the oxygen electrode. The testing system includes a high-temperature test fixture configured to maintain the solid oxide electrolysis cell at an operating temperature. The testing system further includes a gas delivery system configured to supply a lean steam environment or a carbon dioxide-containing environment to the fuel electrode. A current source is configured to operate the solid oxide electrolysis cell under galvanostatic electrolysis conditions to accelerate degradation of the fuel electrode for lifetime evaluation purposes.

A method of accelerated degradation testing of a solid oxide electrolysis cell includes providing a solid oxide electrolysis cell having a fuel electrode, an oxygen electrode, and an electrolyte disposed between the fuel electrode and the oxygen electrode. The method further includes exposing the fuel electrode to a lean steam environment or a carbon dioxide-containing environment. The method further includes operating the solid oxide electrolysis cell under galvanostatic electrolysis conditions to accelerate degradation of the fuel electrode for lifetime evaluation purposes.

The fuel electrode may comprise a nickel-cermet fuel electrode. The electrolyte may comprise yttria-stabilized zirconia. The oxygen electrode may comprise a perovskite-type oxygen electrode. The operating temperature may be 650 °C to 850 °C. The lean steam environment may comprise 1 vol % to 40 vol % steam. The lean steam environment may further comprise at least one of hydrogen, nitrogen, argon, helium, or carbon dioxide. The lean steam environment may possess a steam partial pressure of 0.01 atm to 0.4 atm. The gas delivery system may be configured such that 90% to 99% of supplied steam is converted during electrolysis operation. The current source may be configured to apply a current density of 0.1 A/cm² to 1.0 A/cm². The testing system may further comprise a controller configured to determine a fuel electrode gas flow rate based on an applied electrolysis current according to Faraday's law. The testing system may further comprise a monitoring system configured to monitor at least one of voltage, current, or electrochemical impedance spectroscopy during accelerated degradation testing. The gas delivery system may be configured to expose the fuel electrode to a carbon dioxide-rich environment balanced with hydrogen. The accelerated degradation testing system may be configured to accelerate at least one of nickel coarsening, redox instability, oxygen depletion effects, delamination, carbon deposition, or interfacial cracking while maintaining degradation pathways representative of normal electrolysis operation. The method may further comprise maintaining the solid oxide electrolysis cell at an operating temperature of 750 °C to 850 °C during operation. The lean steam environment may comprise 1 vol % to 40 vol % steam and a balance comprising at least one of hydrogen, nitrogen, argon, helium, or carbon dioxide.

The method may further comprise calculating a fuel electrode gas flow rate as a function of electrolysis current according to Faraday's law to maintain a controlled reducing environment at the fuel electrode. The method may further comprise monitoring at least one of voltage, current, or electrochemical impedance spectroscopy during operation and correlating accelerated degradation results to an expected operational lifetime under normal operating conditions.

### BRIEF DESCRIPTION OF THE DRAWINGS

The features and advantages of the invention are apparent from the following description taken in conjunction with the accompanying drawings in which:

FIG. 1A is a schematic depiction of a state-of-the-art anode-supported solid oxide cell architecture that does not include the stress compensation layer;

FIG. 1B is a schematic depiction of a solid oxide cell that has a stress compensation layer disposed on an outer surface of the anode;

FIG. 2A is a schematic depiction of a state-of-the-art anode-supported solid oxide cell architecture comprising a relatively thick fuel electrode support layer and a first thin dense electrolyte layer;

FIG. 2B is a schematic depiction of a symmetric solid oxide cell structure wherein a second thin electrolyte layer (the compensating layer) is applied to the opposite side of the thick fuel electrode support layer forming a mirror image symmetric configuration;

FIG. 2C is a schematic depiction of an open region introduced on one side of the second electrolyte layer;

FIG. 2D is a schematic depiction of multiple distributed open regions on one side of the second electrolyte layer;

FIG. 3 shows photographs of different cell configurations prior to and after sintering;

FIG. 4A is a photograph that depicts the solid oxide cell having the configuration of FIG. 2A after sintering;

FIG. 4B is a photograph that depicts the solid oxide cell having the configuration of FIG. 2B after sintering;

FIG. 4C is a photograph that depicts the solid oxide cell having the configuration of FIG. 2C after sintering;

FIG. 5A depicts the schematics of a 5×5 cm² single cell assembly;

FIG. 5B depicts the open circuit voltage (OCV) of the single cell under different humidities and comparison with theoretical OCV calculated by thermodynamics;

FIG. 5C depicts an IV change of reversible operation at different steam concentrations;

FIG. 5D depicts area specific resistance (ASR) of the cell at different steam concentrations;

FIG. 6A is a graph that depicts electrochemical impedance spectroscopy of the single cell under open circuit condition;

FIG. 6B depicts quantified polarization and ohmic area specific resistance of the cell under open-circuit voltage (OCV);

FIG. 7A depicts the relation between steam utilization and cell voltage generated from the current-voltage (IV) relationship;

FIG. 7B depicts cell area specific resistance (ASR) under various steam utilizations.

FIG. 7C depicts the electrochemical impedance spectroscopy (EIS);

FIG. 7D depicts the distribution of relaxation times (DRT) of the SOEC under the steam utilization of 50%, 65%, 75%, 82% and 85%, measured at 1.2 V, 1.3 V, 1.4 V 1.5 V and 1.6 V respectively;

FIG. 8A depicts initial IV relation of initial performance of reversible fuel cell under different steam concentration;

FIG. 8B depicts cell ASR variation of SOEC under different steam concentration and utilization;

FIG. 8C depicts electrochemical impedance spectroscopy (EIS);

FIG. 8D is a graph that depicts quantified ohmic area specific resistance and polarization area specific resistance at different time periods;

FIGS. 9A and 9B depict SEM images of the cross-section of the cell after high U_{H}_{₂}_{O} electrolysis near the inlet;

FIGS. 9C and 9D depict SEM images of the outlet of the fuel electrode chamber;

FIG. 10A depicts distribution of pₒ_{₂} and electronic conductivity of an SOEC operated under various voltages at 750 °C, 50% H₂O balanced with H₂ an

$${r}_{i}^{FE \vert EL} = 0.1$$

Ω·cm² under sufficient steam supply (less than 5% U_{H}_{₂}_{O}); and

FIG. 10B depicts distribution of pₒ_{₂} and electronic conductivity of an SOEC operated under various voltages at 750 °C, 3% H₂O balanced with H₂ an

$${r}_{i}^{FE \vert EL} = 0.8$$

Ω·cm² under 94% U_{H}_{₂}_{O}.

### DETAILED DESCRIPTION OF THE INVENTION

Disclosed herein is a flat solid oxide cell (SOC), such as a solid oxide fuel cell (SOFC) or solid oxide electrolysis cell (SOEC) (hereinafter both a solid oxide fuel cell (SOFC) and a solid oxide electrolysis cell (SOEC) will be referred to as “solid oxide cell”), configured with enhanced dimensional stability and reduced curvature through the application of an additional stress-mitigating layer (hereinafter a stress compensation layer). The solid oxide cell addresses the challenge of warping or curving that arises during high-temperature sintering of multilayer ceramic solid oxide cells. In an embodiment, the stress compensation layer has the same material as an electrolyte layer in the solid oxide fuel cell.

Disclosed herein too is a method of manufacturing a solid oxide cell that has a stress compensation layer, which reduces or eliminates the warping or curving that arises during high-temperature sintering of multilayer ceramic solid oxide cells. The method includes forming a multilayer ceramic body comprising a fuel electrode support layer (an anode), an electrolyte layer, and one or more electrode layers and applying a stress compensation layer to a surface of the multilayer ceramic body, where the stress compensation layer includes a material selected to offset shrinkage-induced stresses generated during thermal processing. The method further includes sintering the multilayer ceramic body with the stress compensation layer to reduce thermal stress differentials generated during sintering and thereby reduce curvature of the solid oxide cell.

One technical effect of the use of a stress compensation layer is that it provides mechanical stress balancing during fabrication of a multilayer solid oxide cell structure. The stress compensation layer counterbalances these shrinkage-induced stresses during thermal processing, thereby reducing deformation and promoting formation of a substantially flatter solid oxide cell after sintering. In another embodiment, the stress compensation layer may improve dimensional stability, reduce mechanical failure, and increase manufacturing reproducibility during co-sintering of multilayer ceramic structures. The use of the stress compensation layer may reduce or eliminate the need for external weights, flattening fixtures, or mechanical constraint systems during firing and sintering as well as during thermal cycling. The resulting flatter cell geometry may improve sealing reliability, electrical contact uniformity, stack alignment, gas-flow management, and long-term durability within solid oxide cell stack assemblies. The stress compensation layer may additionally reduce risks of electrolyte fracture, interfacial delamination, edge lifting, and localized stress concentrations generated during thermal cycling.

Another technical effect of the use of a stress compensation layer is that it may permit fabrication of thinner electrolyte structures and thinner multilayer ceramic assemblies while maintaining structural integrity during sintering. This may enable production of lightweight, high-performance solid oxide cells having improved electrochemical efficiency, reduced ohmic resistance, and enhanced thermal cycling capability. The stress compensation architecture may further permit increased manufacturing scalability by improving process consistency across large-area cells and high-volume production processes.

The use of a stress compensation layer may advantageously benefit several industries. In another embodiment, solid oxide cells incorporating stress compensation layers may be used in solid oxide fuel cells (SOFCs), solid oxide electrolysis cells (SOECs), reversible solid oxide cells (RSOCs), hydrogen-production systems, distributed power-generation systems, backup-power systems, aerospace power systems, transportation systems, portable energy systems, marine systems, military power systems, and stationary grid-support applications. The stress compensation structures may be particularly advantageous in large-area ceramic cells, thin-electrolyte architectures, metal-supported solid oxide cells, and modular stack assemblies where flatness, sealing integrity, and thermal durability are important for reliable operation.

Before introducing the technology in detail, some context is provided.

Generally, as used herein, the term “solid oxide cell” generally refers to an electrochemical cell configured to operate at elevated temperature and to convert chemical energy to electrical energy or electrical energy to chemical energy through oxygen ion transport across a solid electrolyte. In one example, a solid oxide cell operates as a fuel cell supplied with a hydrogen-containing fuel and air. Other examples include cells configured for electrolysis operation, reversible operation, or mixed reactant operation. The term does not limit the cell to a particular electrolyte composition, electrode formulation, or mode of operation.

Generally, as used herein, the term “solid oxide fuel cell” (SOFC) is a high-temperature electrochemical device that converts the chemical energy of a fuel directly into electrical energy through electrochemical reactions rather than combustion. An SOFC generates electricity by electrochemically reacting a fuel with an oxidant across a solid ceramic electrolyte that conducts oxygen ions at elevated temperature.

Generally, as used herein, the term “solid oxide electrolysis cell” (SOECs) is a high-temperature electrochemical device that uses electrical energy to convert steam, carbon dioxide, or combinations thereof into useful chemical fuels and feedstocks. An SOEC essentially operates as the reverse of a solid oxide fuel cell (SOFC). While the SOFC consumes fuel to generate electricity, the SOEC consumes electricity to generate fuel or chemical products.

Generally, as used herein, the term “anode”, “cathode” and “electrolyte” refer to an anode layer, a cathode layer or an electrolyte layer. These layers are generally disposed parallel to one another in a solid oxide cell.

Generally, as used herein, the term “lateral dimension” of the solid oxide cell refers to a dimension extending along the plane of the cell, rather than through the thickness of the cell. It generally corresponds to the length, width, diameter, or another in-plane measurement of the cell. For example, if the cell is rectangular, the lateral dimensions are the length and width of the cell. If the cell is circular, the lateral dimension may be the diameter. The “largest lateral dimension” therefore refers to the greatest in-plane distance measured across the cell. Thus, a cell having dimensions of 150 mm×150 mm×1 mm would possess lateral dimensions of 150 mm and 150 mm, while the thickness dimension would be 1 mm. Similarly, a circular cell having a diameter of 120 mm and a thickness of 0.8 mm would possess a largest lateral dimension of 120 mm.

Generally, as used herein, the term “lean steam” refers to an environment having a relatively low steam concentration or low steam partial pressure compared to normal operating conditions of the solid oxide electrolysis cell.

Generally, as used herein, the term DRT, or distribution of relaxation times, is a mathematical analysis technique used in conjunction with electrochemical impedance spectroscopy to separate overlapping electrochemical processes occurring within a solid oxide fuel cell or solid oxide electrolysis cell based on their characteristic time constants.

Generally, as used herein, the term OE, or overpotential, is the additional voltage beyond the thermodynamic equilibrium potential that is involved in driving an electrochemical reaction within a solid oxide fuel cell or solid oxide electrolysis cell at a desired reaction rate.

Generally, as used herein, the term FE, or Faradaic efficiency, is the percentage of electrical charge that is converted into a desired electrochemical reaction product relative to the total electrical charge supplied to the cell.

Generally, as used herein, the term FE-TPB, or Faradaic efficiency at the triple-phase boundary, refers to the efficiency with which charge transfer reactions occurring specifically at the triple-phase boundary region contribute to the formation of the desired electrochemical reaction products.

Generally, as used herein, the term “triple-phase boundary” (also referred to herein as TPB) is the localized region within a solid oxide fuel cell or solid oxide electrolysis cell where three phases simultaneously meet: (1) an electronically conductive phase, such as nickel or another electrode material, (2) an ionically conductive phase, such as a ceramic electrolyte, and (3) a gaseous reactant phase, such as hydrogen, steam, oxygen, or air.

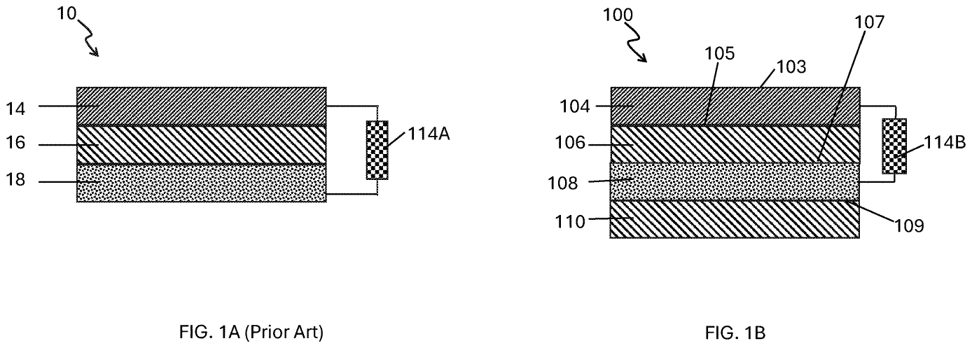

FIG. 1A is a schematic depiction of a cross-sectional view of an exemplary prior art commercial solid oxide cell 10 that may be used for generating electricity. In other words, the solid oxide cell 10 operates as a solid oxide fuel cell that generates electricity by electrochemically reacting a fuel with an oxidant across a solid ceramic electrolyte that conducts oxygen ions at elevated temperatures. The exemplary use of a solid oxide fuel cell in FIG. 1A (in order to detail the problems encountered with this configuration) does not negate the use of a stress compensation layer in other multilayered devices such as a solid oxide electrolysis cell. The solid oxide cell 10 comprises a cathode 14 in communication with an electrolyte 16. An anode 18 (also referred to as the fuel electrode) contacts the electrolyte 16 on a surface that is opposed to a surface that contacts the cathode 14. The outer surfaces of the anode and cathode may contact an anode current collector and a cathode current collector (both not shown) respectively. The drawback of this configuration is that the solid oxide cell undergoes warping during sintering and/or during thermal cycling.

To mitigate this curvature, an additional layer—referred to herein as a stress compensation layer is introduced. The stress compensation layer is applied to one surface of the multilayer ceramic body. This layer is designed to counterbalance the shrinkage-induced stresses that develops during thermal processing. The stress compensation layer may be formed from a ceramic or composite material selected to exhibit shrinkage behavior that offsets the dominant stress vector generated by the other layers. The material properties of this layer, such as thermal expansion coefficient, sintering temperature, and mechanical compliance, are tailored to provide sufficient stress relief without adversely affecting the electrochemical function of the solid oxide cell.

The stress compensation layer may be applied to the anode-facing or cathode-facing side of the solid oxide cell depending on the direction and magnitude of the warping tendency observed during preliminary processing trials. The layer may be co-sintered with the other layers or applied in a post-lamination step prior to firing. In some embodiments, the layer may be porous or partially sintered to allow controlled densification during the sintering cycle, thus enabling dynamic stress compensation as the internal layers shrink.

FIG. 1B depicts is a schematic depiction of a cross-sectional view of an exemplary commercial solid oxide cell 100 that comprises a cathode 104 in contact with an electrolyte 106.

Anode 108 contacts the electrolyte 106 on a first surface 107 of the electrolyte 106 that is opposite to the second surface 105 that contacts the cathode 104. Disposed on the first surface 109 of the anode 108 is a stress compensation layer 110 that prevents the solid oxide fuel cell from warping when it is subjected to sintering or thermal cycling. The stress compensation layer 110 is preferably disposed on an outer surface of the anode 110.

In an embodiment, the stress compensation layer 110 includes a material that has the same composition as the electrolyte 106. While not shown here, the stress compensation layer 110 may also be disposed on a first surface 103 of the cathode opposite the surface 105 that contacts the electrolyte 106. In an embodiment, the stress compensation layer 110 may be simultaneously be disposed on an outer surface of the cathode 104 and the anode 108. Integrating the stress compensation layer 110 with the solid oxide cell 100 reduces the thermal stress differential across the solid oxide cell during high-temperature sintering, resulting in a substantially flatter finished cell. This approach eliminates the need for external weights or mechanical fixtures to flatten the cell during processing and enables more reproducible, scalable, and defect-free manufacturing of solid oxide cells. In an embodiment, the stress compensation layer 110 and the electrolyte 106 have the same thickness and are symmetrically located on opposing surfaces of the anode 108. In another embodiment, the each of the stress compensation layer 110 and the electrolyte 106 are substantially less thick than the anode 108.

In an embodiment, the solid oxide cell 100 generates electrical power by electrochemically reacting a fuel with an oxidant across a solid ceramic electrolyte 106 at elevated temperature. Fuel is supplied to an anode 108 of the fuel cell while air or oxygen is supplied to a cathode 104 of the fuel cell 100. In an embodiment, the fuel supplied to the solid oxide cell may comprise a fuel selected from the group consisting of hydrogen, natural gas, methane, syngas, ammonia, propane, butane, liquefied petroleum gas, biogas, reformate gas, carbon monoxide, ethanol, methanol, diesel-derived reformate, gasoline-derived reformate, hydrocarbon fuels, oxygenated hydrocarbon fuels, synthetic fuels, and a combination thereof. Oxygen molecules at the cathode 104 are converted into oxygen ions that migrate through the electrolyte 106 toward the anode 108, where the oxygen ions react with the fuel to generate electrons, heat, and reaction products. The electrons flow through an external electrical circuit to produce usable electrical power that may be used by load 114B.

Details about the various layers used in the solid oxide cell will now be provided.

Suitable cathode materials (for use in the cathode 104) may include lanthanum strontium manganite (LSM), lanthanum strontium cobalt oxide (LSC), lanthanum strontium cobalt ferrite (LSCF), samarium strontium cobalt oxide (SSC), barium strontium cobalt ferrite (BSCF), praseodymium-containing perovskites, strontium samarium cobaltite (SSC), gadolinium-doped ceria (GDC), doped cerium oxides, or a combination thereof. In some embodiments, the cathode includes SSC-GDC or other mixed ionic-electronic conductors. In some embodiments, the cathode includes lanthanum strontium cobalt ferrite, lanthanum strontium cobaltite, lanthanum strontium manganite, or composite cathodes that include ceria.

A preferred material for the cathode is a mixture of strontium samarium cobaltite (SSC) and gadolinium-doped ceria (GDC). A preferred cathode layer may be formed on the barrier layer by deposition of a cathode ink comprising a composite mixture of strontium samarium cobaltite (SSC) and gadolinium-doped ceria (GDC), commonly referred to as an SSC-GDC cathode composition. The cathode ink may be deposited using a screen-printing process in which the ink is patterned onto the underlying barrier layer through a mesh or stencil structure to achieve a controlled coating thickness and surface morphology. Following deposition, the printed cathode layer may be subjected to drying and sintering processes to form a porous electrochemically active cathode structure.

The cathode 104 may possess porosity levels of 20 to about 50 vol %, preferably 25 to 45 vol %, and more preferably 30 to 40 vol %, based on a total volume of the cathode. The porous structure may comprise interconnected pore networks having pore diameters ranging from nanometer-scale pores to micron-scale pores in order to balance gas permeability, catalytic activity, and mechanical integrity.

The electrolyte 106 is disposed between the cathode 104 and the anode 108. In an embodiment, the electrolyte includes an ion-conducting ceramic layer positioned between the anode and cathode. The electrolyte is generally electronically insulating while being highly conductive to oxygen ions (O²⁻) or, in certain systems, protons (H⁺). The material used in the electrolyte is selected based on ionic conductivity, chemical stability, thermal expansion compatibility, mechanical strength, and operating temperature.

Common electrolytes used in a solid oxide cell includes yttria-stabilized zirconia (YSZ); scandia-stabilized zirconia (ScSZ); gadolinium-doped ceria (GDC or CGO); samarium-doped ceria (SDC); lanthanum gallate-based electrolytes such as lanthanum strontium magnesium gallate (LSGM); stabilized bismuth oxides; proton-conducting ceramics such as barium zirconate-based materials; barium cerate-based electrolytes; composite ceramic electrolytes, or a combination thereof.

In an embodiment, the electrolyte may be yttria-stabilized zirconia, which comprises zirconium oxide stabilized with 3 to 10 mol % yttrium oxide. YSZ exhibits high oxygen-ion conductivity and excellent thermal and chemical stability at elevated temperatures of 600 °C to 1000 °C. The electrolyte 106 in a solid oxide cell may be formed by tape casting, screen printing, slurry coating, plasma spraying, chemical vapor deposition, physical vapor deposition, co-sintering, or electrophoretic deposition processes. Desired electrolyte properties generally include gas impermeability, low electronic conductivity, high ionic conductivity, thermal cycling resistance, and chemical compatibility with adjacent anode and cathode materials.

The electrolyte 106 is generally substantially dense and gas-impermeable, often exhibiting greater than 90%, greater than 95%, or greater than 99% theoretical density in order to prevent mixing of fuel and oxidant gases while maintaining efficient ionic conduction. The electrolyte 106 may possess thicknesses of 2 to 200 μm depending upon whether the cell architecture is electrolyte-supported, anode-supported, or metal-supported. In an anode-supported solid oxide cell, the electrolyte is a dense yttria-stabilized zirconia (YSZ) layer deposited over a porous anode substrate. These electrolytes frequently possess thicknesses of 2 to 20 μm, preferably 3 to 10 μm.

Such thin electrolytes reduce ionic transport distance and permit operation at temperatures ranging from 600 °C to 800 °C. Metal-supported and thin-film SOFC architectures may employ ultrathin electrolytes of 1 to 10 μm thicknesses. Such configurations may be fabricated by sputtering, chemical vapor deposition, atomic layer deposition, pulsed laser deposition, electrophoretic deposition, or other thin-film ceramic processing techniques. For ceria-based electrolytes such as gadolinium-doped ceria (GDC) or samarium-doped ceria (SDC), thicknesses of 5 to 50 μm depending upon whether the layer functions as a primary electrolyte, interlayer, or mixed conducting membrane.

The anode 108 is disposed on the electrolyte 106 and contacts the electrolyte 106. The anode 108 functions as the fuel-side electrode where electrochemical oxidation of fuel occurs. The anode is typically electrically conductive, catalytically active, porous to permit gas transport, and thermally compatible with the electrolyte. Anode materials are selected based upon electronic conductivity, catalytic activity, redox stability, sulfur tolerance, thermal expansion compatibility, and resistance to carbon deposition. In an embodiment, the anode microstructure includes electronically conductive pathways through metallic phases, carbonaceous phases, or a combination thereof, ionically conductive pathways through ceramic phases; and interconnected pore networks for gas transport. This combination forms triple-phase boundary regions where fuel gas, ionic conductor, and electronic conductor intersect to facilitate electrochemical oxidation reactions.

In an embodiment, materials used in the anode 108 in a solid oxide cell includes nickel-yttria stabilized zirconia (Ni-YSZ); nickel-gadolinium doped ceria (Ni-GDC); nickel-samarium doped ceria (Ni-SDC); copper-ceria composites; cobalt-containing cermets; perovskite-based anodes; titanate-based anodes; chromite-based anodes; mixed ionic-electronic conducting ceramic composites, or a combination thereof.

In an embodiment, the anode 108 is a nickel-YSZ cermet comprising metallic nickel dispersed within a yttria-stabilized zirconia matrix. In such systems, nickel provides high electronic conductivity and catalytic activity for hydrogen oxidation and hydrocarbon reforming, while the YSZ phase provides ionic conductivity and thermal expansion compatibility with the electrolyte. The nickel is present in an amount of 30 vol % to 70 vol %, alternatively 40 vol % to 60 vol %, based on a total volume of the anode.

Nickel-GDC and nickel-SDC anodes are employed in intermediate-temperature solid oxide fuel cells because ceria-based phases exhibit higher ionic conductivity and improved catalytic activity at lower temperatures. These materials may additionally provide improved tolerance to hydrocarbon fuels and reduced susceptibility to carbon coking relative to conventional Ni-YSZ systems. The anode in a metal-supported solid oxide cell is configured primarily as a functional electrochemically active layer rather than as a structural support layer and may have a thickness of 1 to 200 μm, preferably 2 to 100 μm, preferably 5 to 50 μm, and more preferably 10 to 40 μm.

In other embodiments, the anode 108 may have a thickness of 1 to 500 μm depending upon cell architecture. Anode thicknesses vary depending upon the functions of the anode and are 5 to 50 μm for functional anode layers; 20 to 50 μm for electrochemically active anode regions; 50 to 500 μm for anode support structures; and 300 to 600 μm for many commercially relevant anode-supported SOFCs. In anode-supported fuel cells, the thick porous anode substrate often serves as the primary structural support for the cell, while a thinner functional anode layer adjacent to the electrolyte provides enhanced electrochemical activity.

The anode 108 generally possesses interconnected porosity to permit transport of fuel gases such as hydrogen, carbon monoxide, methane, syngas, or reformate fuels. In an embodiment, porosity levels include 15% to 60 vol % porosity, preferably 20% to 50 vol % porosity and more preferably 25% to 40 vol % porosity, based on a total volume of the anode 108. Pore sizes be 0.1 to 50 μm, with multimodal pore distributions often being employed to balance gas diffusion, mechanical strength, and electrochemically active triple-phase boundary density.

Anode layers may be fabricated by tape casting, screen printing, slurry coating, extrusion, co-sintering, freeze casting, electrophoretic deposition, plasma spraying, or additive manufacturing processes. Pore formers such as graphite, starch, polymethyl methacrylate (PMMA), cellulose, carbon black, or polymer beads may be incorporated during fabrication to tailor final porosity and gas permeability.

The anode 108 and the cathode both contact electrically conductive current collectors (not shown). The anode 108 contacts a porous anode current collector. In one embodiment, the metal-supported solid oxide cell 100 includes a porous anode current collector positioned adjacent to and in electrical communication with an anode 108. The second porous anode current collector functions to collect and distribute electrons generated during electrochemical oxidation of fuel while simultaneously permitting gaseous fuel transport to electrochemically active regions of the anode. The porous current collector may additionally provide structural reinforcement, current homogenization, thermal distribution, and gas-flow management within the solid oxide cell. In certain embodiments, the porous current collector comprises an electrically conductive and oxidation-resistant metallic structure formed from nickel, nickel alloys, ferritic stainless steels, Fe—Cr alloys, chromium-containing stainless steels, cobalt alloys, copper-containing conductive alloys, porous sintered metal structures, metal foams, woven metallic meshes, expanded metallic screens, perforated metallic plates, an iron-based alloy, a composite metallic laminate or a combination thereof. The porous metallic support includes perforations, woven mesh, expanded metal, sintered metal foam, or laser-cut apertures.

The porous current collector that contacts the anode may possess interconnected porosity sufficient to permit diffusion of fuel gases including hydrogen, methane, syngas, ammonia-derived fuels, reformate gases, or carbon monoxide toward the anode 108. The porous current collector has a porosity of 20% to 80 vol %, preferably 30% to 70 vol %, and preferably 40 to 60 vol %, based on a total volume of the porous current collector that contacts the anode. The average pore diameter is 0.01 to 100 μm, preferably 0.02 to 20 μm. Larger pores may facilitate reduced pressure drop and improved gas transport, while smaller pores may improve electrical contact uniformity and current distribution across the active cell region.

Suitable cathode current collector materials may include metals such as ferritic stainless steels, CROFER® alloys, nickel-containing alloys, silver, platinum, palladium, or a combination thereof; conductive ceramic-metal composites, lanthanum chromite-based materials, lanthanum strontium cobalt oxide (LSC), conductive perovskites, conductive meshes, conductive foams, woven metallic structures, sintered metallic structures, or a combination thereof. In some embodiments, the current collector may possess a density ranging from 7.0 g/cm³ to 10 g/cm³ depending upon composition and porosity.

The cathode current collector may possess porosity levels of 20 volume percent (vol %) to 70 vol %, preferably 30 vol % to about 60 vol %, and more preferably 40 vol % to about 55 vol %. The cathode current collector 102 may possess a thickness of 10 μm to 100 μm, and more preferably 20 μm to 50 μm, with thinner structures (e.g., 20 to 40 μm) being suitable for reduced electrical resistance and compact stack designs.

Having introduced aspects of the technology, some additional features and embodiments of the technology are provided.

The stress compensation layer is generally used to reduce, redistribute, or counterbalance mechanical stresses that develop within a multilayer structure. These stresses may arise from thermal expansion mismatch, lattice mismatch, curing shrinkage, deposition conditions, bending, vibration, or repeated operational cycling. By balancing tensile and compressive forces within the structure, the stress compensation layer helps prevent cracking, delamination, warping, buckling, fracture, and other forms of mechanical failure. In an embodiment, the stress compensation layer has a thickness that is 10% to 100%, preferably 15% to 80%, and more preferably 20% to 75% of the thickness of the anode or the cathode. In an embodiment, the stress compensation layer has a thickness that is substantially less than the thickness of the anode or cathode, upon which it is disposed. In another embodiment, the stress concentration layer has a thickness and/or a composition that is the same as that of the electrolyte. From the FIG. 1B it may be seen that stress compensation layer is disposed across the anode or the cathode from the electrolyte.

In another embodiment, the stress compensation layer has a surface area that is less than a surface area of the electrolyte. In other words, the stress compensation layer may cover 20% to 100%, preferably 30% to 80%, and more preferably 35 to 55% of the surface area of the anode or cathode on at least one surface of the anode or cathode respectively. Those areas of the anode or cathode that are not covered by the stress compensation layer may be used to facilitate contact between the fuel and anode or between the oxidant and cathode respectively.

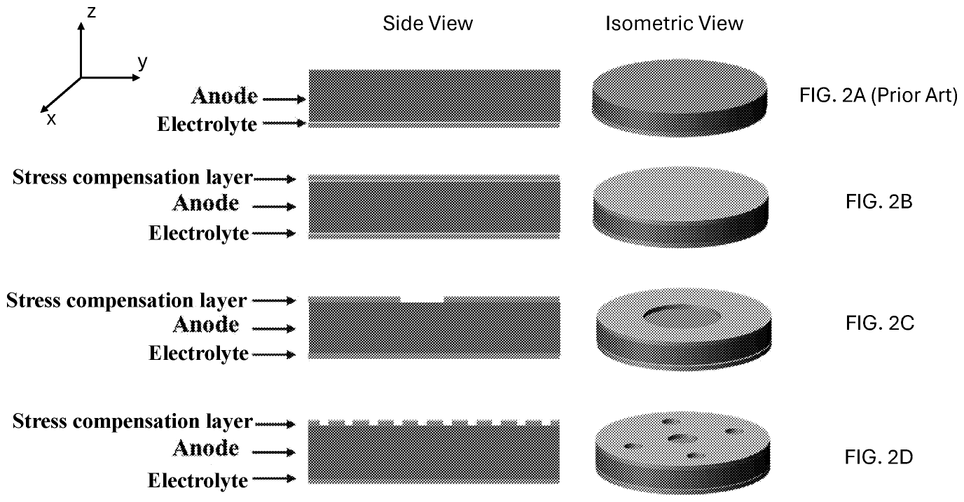

FIG. 2A is a picture that depicts a prior art view of a portion of the solid oxide cell that includes an anode and an electrolyte. FIG. 2A depicts a side view and an isometric view of the portion of the solid oxide cell. It depicts an anode that is substantially thicker than the electrolyte. The configuration depicted in the FIG. 2A may undergo warping when subjected to sintering or thermal cycling.

FIG. 2B-2D depict configurations that prevent warping. In the FIGS. 2B-2D, a second layer (having a same composition as that of the electrolyte) is disposed on an opposing surface of the anode to function as a stress compensation layer. The stress compensation layer generally has the same thickness as that of the electrolyte and may fully or partially cover the surface of the anode or cathode on which it is disposed. FIG. 2B depicts a stress compensation layer (having the same composition as the electrolyte layer) disposed on the anode. The stress compensation layer is disposed on a surface of the anode opposite the surface that contacts the electrolyte. The stress compensation layer has the same thickness as the electrolyte. The stress compensation layer is substantially less in thickness than the thickness of the anode. FIG. 2B illustrates a symmetric solid oxide cell structure wherein a second thin electrolyte layer (the stress compensating layer) is applied to the opposite side of the anode, forming a mirror image architecture. This symmetric configuration is particularly advantageous as it balances thermal and sintering stresses across the z-direction (normal to the cell plane), thereby mitigating curvature and yielding a flat, dimensionally stable ceramic body after sintering. This approach functions analogously to the stress compensation layer discussed earlier and may be used as an alternative or complementary strategy to reduce warping and enhance flatness.

In FIGS. 2C and 2D, it may be seen that the stress compensation layer covers only a portion of the surface of the anode (or cathode). The stress compensation layer can comprise a single opening (FIG. 2C) or a plurality of different sized openings (FIG. 2D) that permit the respective reactant gases to contact the electrode. The openings may have different cross-sectional geometries (e.g., square(s), triangle(s), polygon(s), and the like). In an embodiment, the openings may be arranged in the form of a plurality of concentric circles. Despite the presence of these openings, the stress compensation layer adequately balances tensile and compressive forces within the structure to prevent cracking, delamination, warping, buckling and fracture. This structural adjustment allows for targeted gas access to the anode, improving reactant diffusion pathways and enhancing electrochemical reaction kinetics without compromising the thermal balance that facilitates the retention of flatness. Similarly, the configuration depicted in FIG. 2D introduces multiple distributed open regions on one side of the electrolyte layer, further promoting uniform gas distribution across the anode support. This configuration not only supports improved fuel utilization but also contributes to mechanical stress management by locally relaxing sintering-induced deformation.

The stress compensation layer may be applied to an anode-facing side of the multilayer ceramic body or to a cathode-facing side of the multilayer ceramic body. The stress compensation layer comprises a ceramic material having a shrinkage behavior configured to offset a stress vector generated by the multilayer ceramic body during sintering. The stress compensation layer may comprise a composition similar to that of the electrolyte. The stress compensation layer may also have a thickness and porosity similar to that of the electrolyte. The stress compensation layer may be porous or partially sintered prior to sintering of the multilayer ceramic body. The multilayer ceramic body may be formed by tape casting, isostatic pressing, screen printing, slurry casting, chemical vapor deposition, or a combination thereof. Sintering may comprise co-sintering the multilayer ceramic body and the stress compensation layer. The method may further include forming one or more open regions on one side of the electrolyte to facilitate gas diffusion and reduce sintering-induced deformation.

In various embodiments, the fuel electrode support layer (the anode current collector) is fabricated using methods such as isostatic pressing or tape casting, which allow precise control of layer thickness, uniformity, and green density. After formation of the fuel electrode tape, a functional layer (e.g., the anode) and a dense electrolyte layer are sequentially deposited onto the top surface using coating methods such as screen printing, slurry casting, or chemical vapor deposition. The stress compensation layer may be applied to the anode via tape casting, isostatic pressing, screen printing, slurry casting, chemical vapor deposition, or a combination thereof. These multilayer assemblies are then subjected to co-sintering or staged sintering to achieve densification and adhesion between the interfaces. Sintering or co-sintering is conducted at temperatures of 800 °C to 1600 °C, preferably 1000 °C to 1500 °C.

These architectural variations-when combined with the application of stress-compensating or symmetric layers-provide a versatile design framework for manufacturing flat, high-performance solid oxide cells. The integration of functional porosity and balanced layer design during co-sintering enables the tuning of both electrochemical efficiency and mechanical integrity, addressing longstanding issues associated with curvature, delamination, and sealing failure in solid oxide cells or in solid oxide cell stack assemblies.

In an embodiment, a substantially planar solid oxide cell may possess a total flatness deviation of less than or equal to 5 mm across the largest lateral dimension of the cell. In another embodiment, the substantially planar solid oxide cell may possess a total flatness deviation of less than or equal to 2 mm across the largest lateral dimension of the cell. In another embodiment, the substantially planar solid oxide cell may possess a total flatness deviation of less than or equal to 1 mm across the largest lateral dimension of the cell. In another embodiment, the substantially planar solid oxide cell may possess a total flatness deviation of less than or equal to 500 μm across the largest lateral dimension of the cell. In another embodiment, the substantially planar solid oxide cell may possess a total flatness deviation of less than or equal to 250 μm across the largest lateral dimension of the cell. In another embodiment, the substantially planar solid oxide cell may possess a total flatness deviation of less than or equal to 100 μm across the largest lateral dimension of the cell. In another embodiment, the substantially planar solid oxide cell may possess a local surface waviness of less than or equal to 50 μm over a 100 mm gauge length. In another embodiment, the substantially planar solid oxide cell may possess a local surface waviness of less than or equal to 25 μm over a 100 mm gauge length.

In another embodiment, opposing major surfaces of the solid oxide cell may deviate from parallelism by less than or equal to 2 mm, preferably less than or equal to 500 μm, and preferably less than or equal to 100 μm across the cell width. In another embodiment, the solid oxide cell may possess a thickness variation of less than or equal to 20%, preferably less than or equal to 10%, and preferably less than or equal to 5% relative to an average cell thickness measured across the active area. In another embodiment, the substantially planar solid oxide cell may possess an average out-of-plane displacement of 10 μm to 2 mm, preferably 25 μm to 1 mm, and preferably 50 μm to 500 μm relative to a reference plane extending across the cell. In another embodiment, the substantially planar solid oxide cell may possess a maximum out-of-plane deviation that is less than or equal to 1%, preferably less than or equal to 0.5%, and preferably less than or equal to 0.1% of a longest lateral dimension of the cell.

Flat solid oxide fuel cells provide numerous advantages associated with manufacturability, power density, thermal management, and stack integration. The planar geometry permits formation of thin electrolyte and electrode layers over relatively large surface areas, thereby reducing ionic resistance and improving electrical efficiency. Flat cell architectures additionally facilitate compact stacking arrangements with short current paths and high volumetric power density. The generally uniform layer geometry supports use of conventional fabrication techniques such as tape casting, screen printing, lamination, sputtering, vapor deposition, and co-sintering, thereby reducing manufacturing complexity and cost. Planar fuel cells may further provide improved sealing characteristics and simplified integration with metallic interconnects, gas flow channels, and current collectors. In another embodiment, the flat configuration permits more uniform gas distribution and heat transfer across the active area, thereby reducing localized hot spots and improving electrochemical stability. The planar architecture may also facilitate modular scaling for stationary power systems, combined heat and power systems, industrial energy recovery systems, and distributed generation platforms.

A solid fuel cell that incorporates a stress compensation layer may be particularly advantageous in industrial environments involving high temperatures, repeated thermal cycling, mechanical vibration, or large-area multilayer ceramic structures. The stress compensation layer may improve structural integrity, reduce cracking and delamination, and increase operational lifetime under demanding operating conditions.

Such systems may be advantageously used in stationary power generation systems for industrial plants, manufacturing facilities, hospitals, data centers, and distributed grid-support installations. In these environments, solid oxide fuel cells and direct carbon fuel cells often operate at temperatures ranging from about 500 °C to 1000 °C, where thermal expansion mismatch between electrolyte layers, electrode layers, interconnects, and seal materials can generate substantial internal stress. A stress compensation layer may reduce thermomechanical fatigue and improve long-duration reliability during startup and shutdown cycles.

The technology may also be advantageous in combined heat and power (CUP) systems where both electricity and process heat are generated simultaneously. Industrial cogeneration systems frequently experience fluctuating thermal loads, and the stress compensation layer may reduce warping or fracture associated with repeated heating and cooling. Chemical processing facilities, refineries, pulp and paper mills, steel plants, glass manufacturing facilities, and cement plants may particularly benefit because these facilities already possess high-temperature process streams and may integrate fuel cells into existing thermal infrastructure.

In another embodiment, the solid fuel cell may be used in carbon-consuming or biomass-derived fuel systems that utilize coal, coke, char, biochar, municipal solid waste-derived carbon, or other solid carbonaceous fuels. Direct carbon fuel cells often contain ceramic electrolytes and layered electrode assemblies that are susceptible to stress concentrations caused by uneven fuel distribution, localized hot spots, ash accumulation, and thermal gradients. The stress compensation layer may improve resistance to crack propagation and extend operational durability in these harsh environments.

The technology may additionally be useful in marine propulsion systems, locomotives, heavy mining equipment, and military mobile power systems where vibration and mechanical shock may otherwise damage brittle ceramic structures. In aerospace auxiliary power units and remote off-grid installations, the stress compensation layer may improve reliability during rapid thermal transitions and intermittent operation.

In another embodiment, the stress compensation layer may facilitate scaling of fuel cell stacks to larger active areas. Large-area ceramic cells often experience bowing, edge stress accumulation, and differential shrinkage during fabrication and operation. By balancing tensile and compressive stresses, the compensation layer may permit manufacture of larger fuel cell stacks with improved flatness, sealing performance, and electrical contact stability.

The stress compensation layer may also improve compatibility between materials having substantially different coefficients of thermal expansion, such as ceramic electrolytes, metallic interconnects, conductive perovskites, ferritic stainless steels, nickel-based anodes, or glass-ceramic sealants. As a result, the layer may enhance long-term durability in high-efficiency solid oxide fuel cells, solid oxide electrolysis cells, reversible fuel cell systems, and hybrid energy platforms integrating turbines or thermal recovery systems.

As noted above, there is a need for a rapid testing protocol to determine the lifetime of solid oxide cells, and in particular solid oxide electrolysis cells. The protocol may also be used for solid oxide fuel cells. This evaluation is completed in a significantly reduced timeframe compared to the full service life of the solid oxide electrolysis cell. In other words, the protocol enables accelerated assessment, yielding results in a fraction of the time otherwise utilized to observe natural end-of-life degradation in solid oxide cells. In particular, solid oxide electrolysis cells (SOECs) are subjected to long-duration testing in order to evaluate performance evolution over time. Although increasing the operating temperature can accelerate degradation processes, such conditions may induce failure mechanisms of solid oxide electrolysis cells that are not representative of those occurring under existing operating temperatures, thereby compromising the relevance and validity of the accelerated degradation results. The disclosed accelerated testing protocol enables quantification of the operational lifetime of a solid oxide cell (SOEC) based on data obtained from a shortened testing period. This approach significantly reduces the duration and energy consumption associated with existing lifetime testing procedures. While the methods disclosed herein may apply to either solid oxide fuel cells or to solid oxide electrolysis cells, the remainder of this protocol will be directed to just solid oxide electrolysis cells in the interests of brevity.

Disclosed herein is a solid oxide electrolysis cell testing system that includes a solid oxide electrolysis cell having a fuel electrode, an oxygen electrode, and an electrolyte disposed between the fuel electrode and the oxygen electrode. The testing system includes a high-temperature test fixture configured to maintain the solid oxide electrolysis cell at an operating temperature. The testing system further includes a gas delivery system configured to supply a lean steam environment or a carbon dioxide-containing environment to the fuel electrode. A current source is configured to operate the solid oxide electrolysis cell under galvanostatic electrolysis conditions to accelerate degradation of the fuel electrode for lifetime evaluation purposes.

Disclosed herein too is a method of accelerated degradation testing of a solid oxide electrolysis cell includes providing a solid oxide electrolysis cell having a fuel electrode, an oxygen electrode, and an electrolyte disposed between the fuel electrode and the oxygen electrode. The method further includes exposing the fuel electrode to a lean steam environment or a carbon dioxide-containing environment. The method further includes operating the solid oxide electrolysis cell under galvanostatic electrolysis conditions to accelerate degradation of the fuel electrode for lifetime evaluation purposes.

This accelerated testing protocol amplifies the degradation-driving forces at the fuel electrode by exposing it to a lean steam or carbon dioxide (CO₂) environments. This approach quantitatively increases the degradation rate of the solid oxide electrolysis cell while maintaining fidelity to intrinsic degradation mechanisms observed under standard operating conditions. The protocol is directed toward the fuel electrode of the solid oxide electrolysis cell, which has a nickel cermet-based fuel electrode (e.g., the anode) and often represents the primary site of degradation during the solid oxide electrolysis cell operation.

In an embodiment, degradation of the nickel cermet fuel electrode frequently dictates the overall lifetime of the of the solid oxide electrolysis cell. This degradation can be driven by reducing environments that form at the electrode/electrolyte interface, particularly under typical electrolysis conditions. These environments may result in the partial reduction of the ceramic electrolyte, such as yttria-stabilized zirconia (YSZ), leading to the formation of cracks and delamination at the interface between the nickel and the ceramic phase. Thus, the term, “lean steam or carbon dioxide environments” means intentionally operating the fuel electrode under relatively steam-deficient conditions, or under CO₂-rich conditions, to accelerate aging and degradation while still preserving degradation pathways representative of real-world operation.

To magnify these degradation-driving forces in a controlled and quantifiable manner, the accelerated testing protocol introduces either lean steam or carbon dioxide (CO₂) to the fuel electrode compartment under galvanostatic electrolysis conditions. The galvanostatic operation ensures that a constant current is applied across the cell, thereby enabling a consistent electrochemical driving force for degradation over the test period.

In this context, “lean steam” refers to an environment having a relatively low steam concentration or low steam partial pressure compared to normal operating conditions of the solid oxide electrolysis cell. In other words, the gas stream supplied to the fuel electrode contains less water vapor and proportionally more reducing gas (such as hydrogen) or inert carrier gas. In an embodiment, the fuel electrode of the solid oxide electrolysis cell is exposed to a lean steam environment during accelerated degradation testing. The lean steam environment may comprise 1 vol % to 40 vol % steam, preferably 2 vol % to 30 vol % steam, and preferably 5 vol % to 20 vol % steam, with the balance comprising at least one of hydrogen, nitrogen, argon, helium or carbon dioxide. In another embodiment, the lean steam environment may possess a steam partial pressure of 0.01 atm to 0.4 atm, preferably 0.02 atm to 0.25 atm, and preferably 0.05 atm to 0.15 atm. In another embodiment, the lean steam environment comprises less than 50 vol % steam, preferably less than 30 vol % steam, and preferably less than 20 vol % steam. The reduced steam concentration increases reducing conditions at the nickel-containing fuel electrode and accelerates degradation mechanisms including nickel coarsening, delamination, oxygen depletion effects, and redox-related degradation while maintaining degradation pathways representative of normal electrolysis operation.

For a nickel-cermet fuel electrode, operating under lean steam conditions can accelerate degradation because insufficient steam availability may promote phenomena such as nickel coarsening, redox instability, carbon deposition (in carbon-containing feeds), local oxygen depletion, and microstructural damage. The reduced steam activity also changes the electrochemical driving forces and chemical potentials at the electrode/electrolyte interface, thereby stressing the electrode materials more aggressively than under standard steam-rich electrolysis operation.

The fuel electrode gas flow rate (F_{FE}) is calculated as a function of the applied electrolysis current, thereby maintaining a controlled gas-phase composition relative to the oxygen evolution reaction rate. This stoichiometric control ensures the fuel electrode is exposed to a lean (oxygen-deficient) environment that replicates realistic degradation conditions without inducing artificial failure modes unrelated to the standard solid oxide electrolysis cell operation. The fuel electrode gas flow rate (F_{FE}) is calculated is shown below:

$${F}_{FE} = \frac{{IV}_{m}}{2 {Fy}_{{H}_{2} O}}$$

where I is the electrolysis current, Vₘ is molar volume at standard state (at 1 atmosphere and 0 °C), y_{H2O} is the molar fraction of steam in the inlet stream of the fuel electrode and F is the Faraday constant.

While the solid oxide electrolysis cell may include any of the aforementioned electrodes and electrolyte, in an embodiment, the accelerated degradation testing protocol may be effectively carried out using a solid oxide electrolysis cell comprising a nickel-based cermet fuel electrode (the anode), a dense ceramic electrolyte such as yttria-stabilized zirconia (YSZ), and a perovskite-type oxygen electrode (the cathode). The solid oxide electrolysis cell is mounted within a high-temperature test fixture capable of maintaining an operating temperature of 750 °C to 850 °C. The fuel electrode is exposed to a controlled gas environment comprising either lean steam or carbon dioxide (CO₂) balanced with hydrogen. The flow rate of the steam was selected to convert 90% to 99% of the steam to impose reducing conditions that amplify degradation-driving forces without introducing non-representative mechanisms.

The electrochemical operation is conducted under galvanostatic conditions, wherein a constant current density (e.g., 0.1 to 1.0 A/cm²) is applied across the cell using a current source or potentiostat/galvanostat, with the polarity set such that the fuel electrode functions as the cathode. The fuel electrode gas flow rate (F_{FE}) is determined based on the applied electrolysis current and is calculated stoichiometrically using Faraday's law to ensure consistent and quantifiable degradation acceleration. Throughout the test, cell performance is monitored via voltage, current, and optionally electrochemical impedance spectroscopy (EIS).

After the accelerated aging period—which is significantly shorter than existing lifetime tests—the cell may be subjected to post-mortem analysis including scanning electron microscopy (SEM), X-ray diffraction (XRD), and cross-sectional imaging to assess material degradation, interfacial cracking, and phase changes. The degradation rate observed under the accelerated protocol is then correlated to the expected lifetime of the solid oxide electrolysis cell under normal operating conditions, allowing quantitative prediction of cell durability with reduced testing time and energy consumption.

The accelerated degradation testing method described herein offers significant advantages over existing long-term testing approaches. By intensifying the degradation-driving forces under controlled conditions that mimic real operational environments, the protocol enables rapid and quantifiable evaluation of solid oxide electrolysis cell lifetime without introducing artificial failure mechanisms. This substantially reduces the duration, energy consumption, and resource requirements associated with durability testing, thereby facilitating faster material screening, cell design optimization, and reliability assessment in a cost-effective and scientifically valid manner.

This flat solid oxide cell and the accelerated testing is exemplified by the following non-limiting examples.

### EXAMPLE

### Example 1

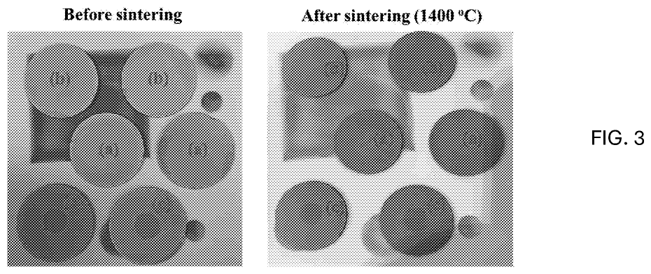

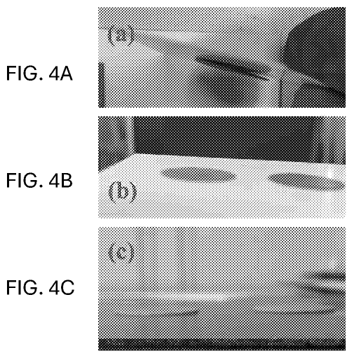

This example depicts the manufacturing flat solid oxide cells having the configurations represented in FIGS. 2B, 2C and 2D. FIG. 3 depicts these as manufactured cells before and after sintering. In FIG. 4A, solid oxide cells labelled (a) have the configuration depicted in FIG. 2A, while cells labelled (b) (See FIG. 4B) have the configuration depicted in FIG. 2B and cells labelled (c) (See FIG. 4C) have the configuration depicted in FIG. 2C.

FIGS. 4A, 4B and 4C shows the cells with configurations (a), (b), and (c) after being sintered at 1400 °C without a weight loading. Significant curving can be observed with the classic configuration (a). While the configuration (c) (See FIG. 4C) (having the configuration shown in FIG. 2C with an open circular area at the center), shows a slight curvature at the edge, due to the different shrinkage between the center and the edge. The above experiment validates the concept that by applying an additional electrolyte layer on the other side, the curvature of the thin anode supported cell can be mitigated. From this example, it may be seen that ultra-thin, free-standing design significantly reduces the thickness of the device while maintaining the functional layered structure. This transition from a bulk planar geometry to an ultra-thin configuration enables excellent mechanical flexibility, allowing the solid oxide cell to sustain various bending angles without cracking or performance degradation.

### Example 2

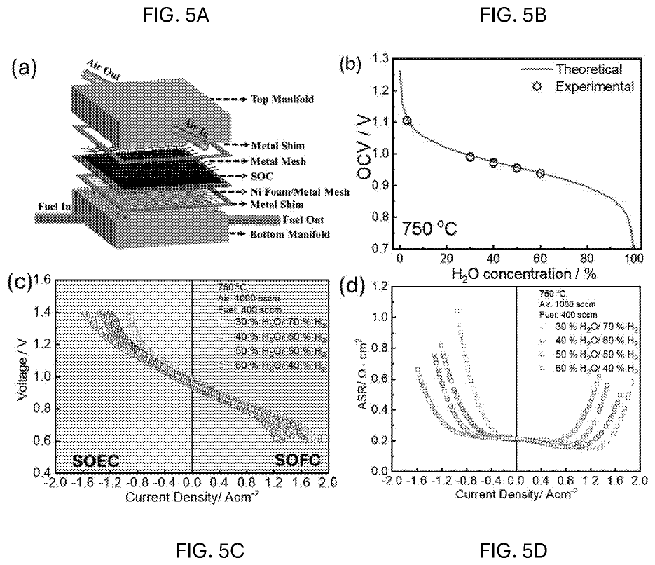

This example is conducted to demonstrate accelerated testing protocols in a solid oxide fuel cell. A 5 cm×5 cm single cell with an air electrode area of 16 cm² was tested using a stainless steel-based manifold, as illustrated in the schematic in FIG. 5A. FIG. 5A depicts the schematics of a 5×5 cm² single cell assembly; FIG. 5B depicts the open circuit voltage (OCV) of the single cell under different humidities and comparison with theoretical OCV calculated by thermodynamics; FIG. 5C depicts an IV change of reversible operation at different steam concentrations; and FIG. 5D depicts area specific resistance (ASR) of the cell at different steam concentrations. The OCV under different H₂O % matches with the value calculated from the equilibrium thermodynamics in FIG. 5B, indicating the cell is well sealed. Reversible cell performance was evaluated under varying steam concentrations, 30%, 40%, 50%, and 60% H₂O balanced with H₂, at 750 °C. Under an applied voltage of 1.3 V, the corresponding electrolysis current densities reached 0.848, 1.113, 1.223, and 1.386 A/cm², respectively. The slope of the i-V curves represent the total ASR of the cell, which corresponds to the total cell impedance (Z_{Cell}) at 0 Hz. FIG. 5D presents the ASR versus current density, determined by differentiating the i-V curves across the range of steam concentrations. The ASR remains nearly constant, between 0.22 and 0.28 Ω·cm², under OCV and low current density conditions. However, ASR increases at higher current densities due to local depletion of H₂ in SOFC mode or H₂O in SOEC mode. This increase is consistent with the concentration polarization observed in the i-V curves.

Electrochemical impedance spectroscopy (EIS) is an electrochemical characterization technique used to evaluate the performance and degradation behavior of a solid oxide fuel cell or solid oxide electrolysis cell. In EIS analysis, a small alternating current perturbation is applied across the cell over a range of frequencies and the resulting impedance response is measured. The impedance response may be used to characterize electrolyte resistance, electrode polarization resistance, charge-transfer processes, gas diffusion limitations, interfacial degradation, and mass transport behavior within the cell. The measured impedance may be represented as a complex impedance having real and imaginary components and may be displayed using Nyquist plots or Bode plots. In another embodiment, the high-frequency intercept of the impedance spectrum corresponds to the ohmic resistance of the cell, while lower-frequency arcs correspond to electrochemical polarization and transport-related processes. In yet another embodiment, the total cell impedance measured at approximately 0 Hz corresponds to the total area-specific resistance (ASR) of the cell under direct current operating conditions.

DRT, or distribution of relaxation times, is a mathematical analysis technique used in conjunction with electrochemical impedance spectroscopy to separate overlapping electrochemical processes occurring within a solid oxide fuel cell or solid oxide electrolysis cell based on their characteristic time constants. FE, or Faradaic efficiency, represents the percentage of electrical charge that is successfully converted into a desired electrochemical reaction product, such as hydrogen generation during electrolysis, relative to the total charge passed through the cell.

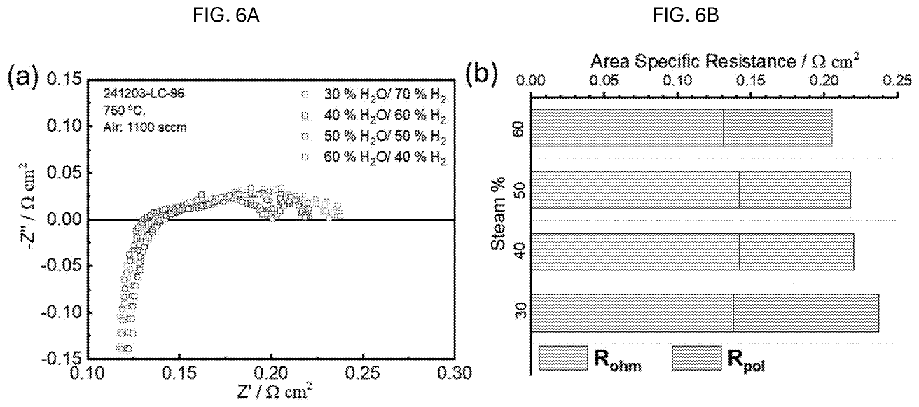

FIG. 6A is a graph that depicts EIS of the single cell under open circuit condition. FIG. 6B depicts quantified polarization and ohmic area specific resistance of the cell under OCV. EIS results under OCV conditions for various H₂O/H₂ ratios are shown in FIG. 6A. FIG. 6B provides the extracted ohmic resistance (R_{Ohm}) and polarization resistance (R_{Pol}) from the EIS data. R_{Ohm} exhibits minimal dependence on steam concentration, whereas R_{Pol} decreases with increasing steam content.

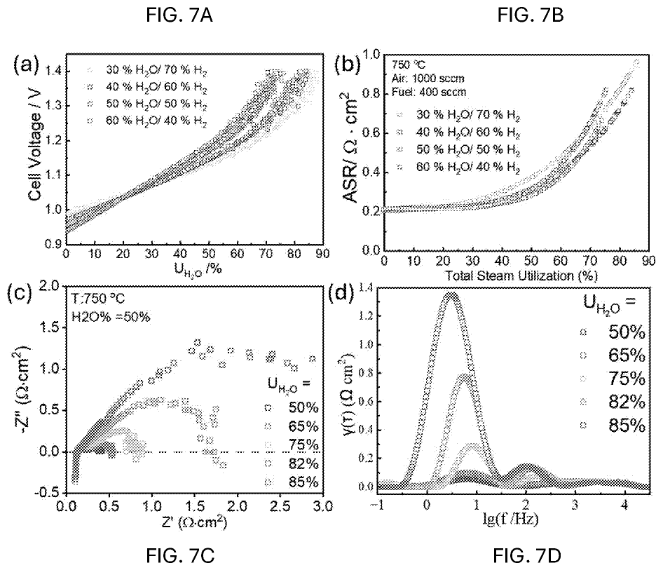

FIG. 7A depicts the relation between steam utilization and cell voltage generated from the IV relation. FIG. 7B depicts cell ASR under various steam utilizations. FIG. 7C depicts the EIS and FIG. 7D depicts the DRT of the SOEC under the steam utilization of 50%, 65%, 75%, 82% and 85%, measured at 1.2 V, 1.3 V, 1.4 V 1.5 V and 1.6 V respectively.

U_{H}_{₂}_{O} is evaluated from the current density (I), active area (A), the total flow rate in the FE (ν_{FE}) and the molar steam fraction in the fed H₂/H₂O mixture (y_{H}_{₂}_{O}) by

$${U}_{{H}_{2} O} = \frac{IA}{{z}_{{H}_{2} O} {Fy}_{{H}_{2} O} {v}_{FE}}$$

From FIG. 7B, it may be seen that the ASR remains nearly constant, between 0.22 and 0.28 Ω·cm², under OCV and low current density conditions. However, ASR increases at higher current densities due to local depletion of H₂ in SOFC mode or H₂O in SOEC mode. This increase is consistent with the concentration polarization observed in i-V curves. Consistent with this trend, EIS shows that the R_{Pol} increases by roughly an order of magnitude as the U_{H}_{₂}_{O} increases from 50% to 85%, leading to a highly reducing environment near the FE and the electrode/electrolyte interface. Such changes in redox environment across the SOEC can impact performance stability significantly. FIG. 7D presents the DRT analysis of R_{Pol}, resolved by relaxation frequency. The peak at the frequency range of 1 to 3 kHz is attributed to charge transfer reactions at the FE, while the peak at 0.1-10 Hz corresponds to gas diffusion resistance in the FE. Both contributions increase with increasing U_{H}_{₂}_{O}, indicating enhanced electrochemical kinetics and mass transport under higher steam conditions.

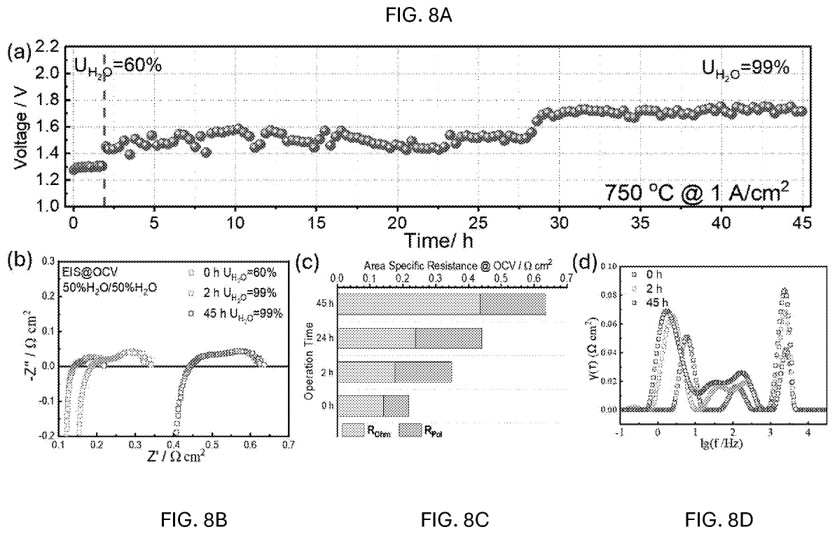

FIG. 8A depicts initial IV relation of initial performance of reversible fuel cell under different steam concentration; FIG. 8B depicts cell ASR variation of SOEC under different steam concentration and utilization; FIG. 8C depicts EIS; while FIG. 8D is a graph that depicts quantified ohmic ASR and polarization ASR at different time periods. The SOEC underwent constant current electrolysis at 1 A/cm² and 50% H₂O concentration as shown in FIG. 8A. During first two hours, 400 sccm H₂O/H₂ was fed to the SOEC to maintain an overall U_{H}_{₂}_{O} of 60%. The cell voltage stabilized at 1.30 V during the first two hours. At the 2nd hour, the flow rates decreased to 236 sccm H₂O/H₂, with a constant current density of 1 A/cm². The voltage shows a substantial increase to 1.48V, owing to the concentration polarization. At the 28th hour, the cell voltage further increased and stabilized at 1.71 to 1.75V, up to 45 hours. FIG. 8B shows the evolution of EIS during the electrolysis under high steam concentrations and FIG. 8C gives the quantified R_{Ohm} and R_{Pol} during the electrolysis process. The differences of impedance at 0^{th} hour and 2^{nd} hour mainly come from change in H₂O/H₂ flow rate. High flow rate offers better gas transport and shows a low polarization resistance. During the 22 hours of electrolysis at U_{H}_{₂}_{O} of 99%, R_{Ohm} grows from 0.177 to 0.238 Ω·cm² by 34% and R_{Pol} grows from 0.171 to 0.202 Ω·cm² by 18%. After 43 hours electrolysis at U_{H}_{₂}_{O} of 99%, R_{Ohm} further grows to 0.435 Ω·cm² by 146% and R_{Pol} increases to 0.201 Ω·cm² by 18%. The great increase in R_{Ohm} indicates the electrolyte or interfacial degradation dominates during the high U_{H}_{₂}_{O} electrolysis.

During the electrolysis in the single cell at U_{H}_{₂}_{O}=99%, R_{Ohm} increases by 146%, while R_{Pol} only increases by 18%. R_{Ohm} is mainly contributed by the oxygen ion conduction in the electrolyte while electrode polarization contributes to R_{Pol}, suggesting that degradation occurs primarily inside the electrolyte, with intact electrodes and the interfaces between electrode and electrolyte.

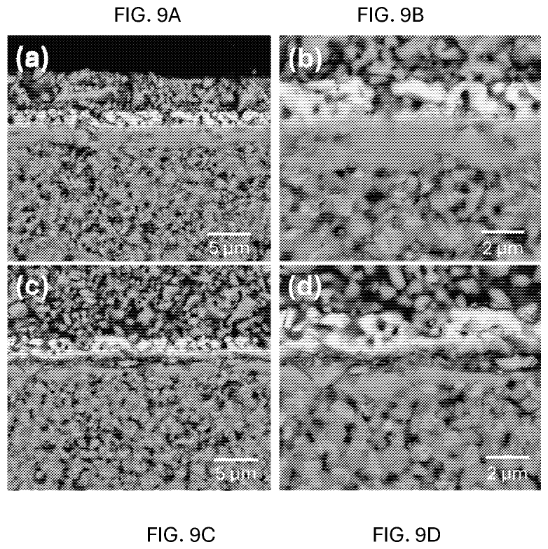

FIGS. 9A and 9B depict SEM images of the cross-section of the cell after high U_{H}_{₂}_{O} electrolysis near the inlet; while FIGS. 9C and 9D depict SEM images of the outlet of the fuel electrode chamber. Cracks are only observed at the outlet part of the cell shown in FIGS. 9C and 9D. SEM images of the SOEC cross-section near the inlet (see FIGS. 9A-9D) after the test reveal that a crack forms in the YSZ electrolyte at fuel outlet part of the cell, (see FIGS. 9C and 9D), where steam concentration is extremely low. In contrast, no crack is observed in the electrolyte near the steam inlet, (see FIGS. 9A and 9B), which is fed with abundant steam. The high U_{H}_{₂}_{O} drives the local depletion of steam and causes the crack formation inside the electrolyte where the steam concentration is low.

The high-angle annular dark-field-scanning transmission electron microscope was also performed. The high-angle annular dark-field-scanning transmission electron microscope (HAADF-STEM) images show the formation of an interaction layer between porous GDC buffer layer and large grained YSZ electrolyte. The layer is composed of densely packed grains of 100 to 200 nm thickness, with a mixture of elements of Gd, Ce, Y, and Zr. Within this layer, the Ce atomic concentration decreases linearly from 36% down to about 5%, while the Zr concentration increases almost linearly from 6% to about 39%. The formation of this dense layer is attributed to the diffusion of Ce and Gd into YSZ during sintering. Therefore, this layer is referred to as Ce-diffused YSZ. The addition of Ce dopant in YSZ attributes a significantly lower ionic conductivity, and higher n-type electronic conductivity of the interfacial layer than the bulk of YSZ. It is seen that electrolysis operation induces a crack between the Ce-diffused YSZ layer and the single-grained YSZ. Multiple nanosized pores occur in the Ce-diffused YSZ layer near its interface with YSZ, implying the structure changes in Ce-diffused YSZ, attributed to the polarization of the electrolyte. The crack separates the bulk region with significant Ce concentration from the Ce-free region of the dense electrolyte, indicating that the introduction of Ce into the dense layer plays a critical role in crack formation during electrolysis under high U_{H}_{₂}_{O}. The polarization of cells contributes to the change of redox environments across the SOC, which is reflected by the local pₒ_{₂} and oxygen content. Electron energy loss spectroscopy (EELS) mapping was performed to analyze the oxygen content in the electrolyte samples before and after electrolysis. EELS provides greater precision for detecting light elements, such as oxygen, compared to energy-dispersive X-ray (EDX) analysis. The oxygen percentage in the Ce-diffused YSZ of the cracked cell is 2 to 3% lower than that in the original cell, within a 400 nm region from the interface with YSZ. The limited oxygen ion supply from the FE during the high U_{H}_{₂}_{O} electrolysis results in the slight reduction of Ce-diffused YSZ and the local structure changes.

The higher electron concentration in Ce-doped YSZ increases

$${σ}_{{e}^{′}}^{0}$$

and introduces significant n-type electronic conduction under reducing conditions. Under sufficient steam supply, U_{H}_{₂}_{O} is low and the steam concentration at the FE TPB can closely match the feed gas composition. In such conditions, the hydrogen evolution reaction (HER) has a faster kinetics over the oxygen evolution reaction (OER), resulting in lower FE ionic resistance

$$( {r}_{i}^{FE \vert EL} )$$

compared to the ionic resistance of OE

$$( {r}_{i}^{OE \vert EL} ) .$$

Near the inlet of the FE, U_{H}_{₂}_{O} is typically low (<5%), resulting in a local high steam concentration at the FE and electrolyte interface.

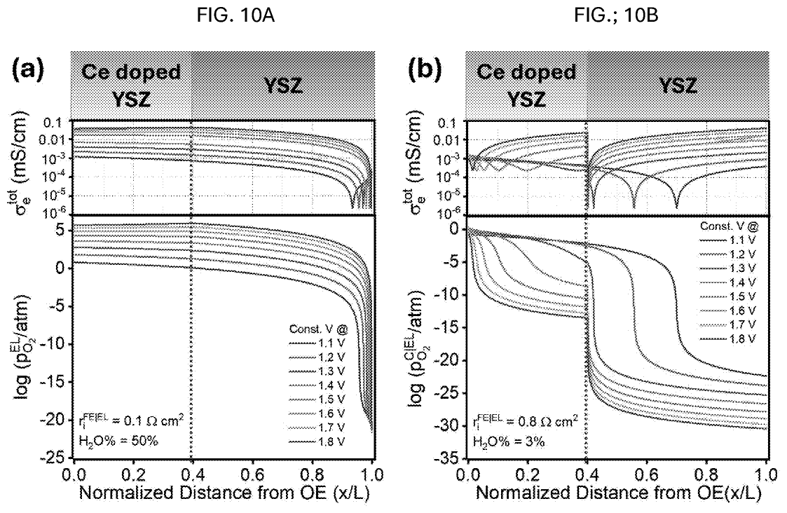

FIG. 10A depicts distribution of pₒ_{₂} and electronic conductivity of an SOEC operated under various voltages at 750 °C, 50% H₂O balanced with H₂ and

$${r}_{i}^{FE \vert EL} = 0.1$$

Ω·cm² under sufficient steam supply (less than 5% U_{H}_{₂}_{O});

FIG. 10B depicts distribution of pₒ_{₂} and electronic conductivity of an SOEC operated under various voltages at 750 °C, 3% H₂O balanced with H₂ and

$${r}_{i}^{FE \vert EL} = 0.8$$

Q·cm² under 94% U_{H}_{₂}_{O}. The pₒ_{₂} at the interface between YSZ and Ce-diffused-YSZ (x/L=0.4) when cell operates with different

$${r}_{i}^{FE \vert EL}$$

and steam concentration at the FE|EL interface. FIG. 10A illustrates the total electronic conductivity,

$${σ}_{e}^{tot} ,$$

across the two regions of the electrolyte and the associated

$${p}_{{O}_{2}}^{EL}$$

as a function of electrolysis voltage and 50% steam concentration in the FE. The nonlinear shape of log

$$( {p}_{{O}_{2}}^{EL} )$$

is attributed to the variation of total electronic conductivity

$${σ}_{e}^{tot}$$

across the electrolyte.

$$\frac{d log ( {p}_{{O}_{2}}^{EL} )}{dx} = \frac{4 F}{RT} ( \frac{{I}_{i}}{{σ}_{i}} - \frac{{I}_{e}}{{σ}_{e}^{tot}} ) \qquad [ 2 ]$$

The local

$${σ}_{e}^{tot}$$

is determined by

$${p}_{{O}_{2}}^{EL} ,$$

while the change of

$${p}_{{O}_{2}}^{EL}$$

along the thickness direction of electrolyte is influenced by local

$${σ}_{e}^{tot} .$$

The spatial minimum in

$${σ}_{e}^{tot} ,$$

stemming from the V-shaped population minimum of the electronic charge carriers in the Brouwer diagram, results in the sharp drop of log pₒ_{₂} value near the YSZ region adjacent to the FE. The minimum in

$${σ}_{e}^{tot}$$

occurs at

$$log ( {p}_{{O}_{2}}^{EL} ) = - 12.2$$

for all voltages investigated, which agrees with the result from Park's work⁵¹. Under various applied voltages, most of the Ce-doped YSZ remains in a high pₒ_{₂} region (>1 atm), preventing Ce (IV) reduction and maintaining stable electronic conductivity, oxygen potential, and lattice structure. However, the oxygen evolution and electrolyte interface experiences extremely high pₒ_{₂} under high electrolysis voltage, which can result in degradation phenomena such as cracking and delamination.

At high U_{H}_{₂}_{O}, significant concentration polarization occurs, particularly near the outlet of the test fixture, reducing local steam concentrations at the FE and electrolyte interface. Low H₂O concentration also reduces the kinetics of HER and brings up the FE electrode ionic resistance

$$( {r}_{i}^{FE \vert EL} ) .$$

The local FE atmosphere with 3% H₂O balanced by H₂ and

$${r}_{i}^{FE \vert EL} = 0.8$$

Q·cm² is used to simulate the cell under depleted steam supply with about 94% U_{H}_{₂}_{O}. This leads to a dramatically different distribution of pₒ_{₂} and a

$${σ}_{e}^{tot}$$

compared to low-utilization scenarios. As shown in FIG. 10B this leads to a dramatically different distribution of pₒ_{₂} and

$${σ}_{e}^{tot}$$

compared to low-utilization scenarios. The FE and YSZ interface becomes more reducing owing to the lower H₂O % and higher overpotential from high

$${r}_{i}^{FE \vert EL}$$

than the low U_{H}_{₂}_{O} scenarios. In this regime, a larger portion of the YSZ is exposed to reducing conditions, and the minimum

$${σ}_{e}^{tot}$$

shifts toward the OE.

When the applied voltage exceeds 1.4 V, the minimum in

$${σ}_{e}^{tot}$$

within the YSZ region shifts toward the interface with the Ce-doped YSZ, creating a local reducing environment near the boundary. This promotes the reduction of Ce(IV) to Ce(III), increasing the electronic conductivity on the Ce-doped YSZ side. As a result, the pₒ_{₂} drops sharply, by 10 to 15 orders of magnitude, across the narrow (~10 nm) boundary between YSZ and Ce-doped YSZ, driven by the local minimum in

$${σ}_{e}^{tot} .$$

These drastic redox and structural changes lead to Ce reduction and localized lattice expansion on the reducing side of the interface, generating mechanical stress and ultimately causing crack formation.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. A solid oxide cell comprising:
an electrolyte;
an anode disposed on a first surface of the electrolyte;
a cathode disposed on a second surface of the electrolyte opposite the first surface; and
a stress compensation layer disposed on a surface of the anode or the cathode opposite the electrolyte; wherein the stress compensation layer is configured to reduce warping of the solid oxide cell during sintering or thermal cycling.

2. The solid oxide cell of claim 1, wherein the stress compensation layer comprises a same composition as the electrolyte.

3. The solid oxide cell of claim 1, wherein the electrolyte comprises yttria-stabilized zirconia, scandia-stabilized zirconia, gadolinium-doped ceria, samarium-doped ceria, lanthanum strontium magnesium gallate, stabilized bismuth oxide, a proton-conducting ceramic, or a combination thereof.

4. The solid oxide cell of claim 1, wherein the stress compensation layer possesses a thickness that is 10% to 100% of a thickness of the anode or the cathode upon which the stress compensation layer is disposed.

5. The solid oxide cell of claim 1, wherein the stress compensation layer and the electrolyte possess substantially identical thicknesses and are symmetrically positioned on opposing sides of the anode.

6. The solid oxide cell of claim 1, wherein the stress compensation layer covers 20% to 100% of a surface area of the anode or the cathode.

7. The solid oxide cell of claim 1, wherein the stress compensation layer includes one or more openings configured to facilitate reactant gas transport to the anode or the cathode.

8. The solid oxide cell of claim 7, wherein the one or more openings comprise circular openings, polygonal openings, square openings, triangular openings, concentric openings, or combinations thereof.

9. The solid oxide cell of claim 1, wherein the stress compensation layer comprises a ceramic material configured to offset a stress vector generated during sintering of the solid oxide cell.

10. The solid oxide cell of claim 1, wherein the solid oxide cell possesses a total flatness deviation of less than or equal to 1 mm across a largest lateral dimension of the solid oxide cell after sintering.

11. The solid oxide cell of claim 1, wherein the solid oxide cell possesses a maximum out-of-plane deviation less than or equal to 0.5% of a largest lateral dimension of the solid oxide cell after sintering.

12. The solid oxide cell of claim 1, wherein the anode comprises nickel-yttria stabilized zirconia, nickel-gadolinium doped ceria, nickel-samarium doped ceria, a copper-ceria composite, a cobalt-containing cermet, a titanate-based material, a chromite-based material, or a combination thereof.

13. The solid oxide cell of claim 1, wherein the cathode comprises lanthanum strontium manganite, lanthanum strontium cobalt oxide, lanthanum strontium cobalt ferrite, samarium strontium cobalt oxide, barium strontium cobalt ferrite, gadolinium-doped ceria, or a combination thereof.

14. The solid oxide cell of claim 1, wherein the electrolyte and the stress compensation layer both comprise yttria-stabilized zirconia, the anode comprises a nickel-cermet, the cathode comprises samarium strontium cobalt oxide (SSC)-gadolinium-doped ceria (GDC), wherein the wherein the stress compensation layer and the electrolyte possess substantially identical thicknesses and are symmetrically positioned on opposing sides of the anode, the cathode or both the anode and cathode, and wherein the stress compensation layer includes one or more openings configured to facilitate reactant gas transport to the anode or the cathode.

15. The solid oxide cell of claim 1, wherein the solid oxide cell is configured as a solid oxide fuel cell, a solid oxide electrolysis cell, or a reversible solid oxide cell.

16. A solid oxide cell comprising:
an electrolyte;
an anode disposed on a first surface of the electrolyte;
a cathode disposed on a second surface of the electrolyte opposite the first surface; and
a stress compensation layer disposed on a surface of the anode or the cathode opposite the electrolyte; wherein the stress compensation layer is configured to reduce warping of the solid oxide cell during sintering or thermal cycling; wherein the electrolyte and the stress compensation layer both comprise the same material; wherein the material is yttria-stabilized zirconia, scandia-stabilized zirconia, gadolinium-doped ceria, samarium-doped ceria, lanthanum strontium magnesium gallate, stabilized bismuth oxide, a proton-conducting ceramic, or a combination thereof.

17. The solid oxide cell of claim 16, wherein the stress compensation layer includes one or more openings configured to facilitate reactant gas transport to the anode or the cathode; and wherein the one or more openings comprise circular openings, polygonal openings, square openings, triangular openings, concentric openings, or combinations thereof.

18. The solid oxide cell of claim 16, wherein the stress compensation layer and the electrolyte possess substantially identical thicknesses and are symmetrically positioned on opposing sides of the anode, the cathode or both the anode and cathode.

19. The solid oxide cell of claim 16, wherein the anode comprises nickel-yttria stabilized zirconia, nickel-gadolinium doped ceria, nickel-samarium doped ceria, a copper-ceria composite, a cobalt-containing cermet, a titanate-based material, a chromite-based material, or a combination thereof, and wherein the cathode comprises lanthanum strontium manganite, lanthanum strontium cobalt oxide, lanthanum strontium cobalt ferrite, samarium strontium cobalt oxide, barium strontium cobalt ferrite, gadolinium-doped ceria, or a combination thereof.

20. A solid oxide cell comprising:
an electrolyte;
an anode disposed on a first surface of the electrolyte; wherein the anode comprises nickel-yttria stabilized zirconia, nickel-gadolinium doped ceria, nickel-samarium doped ceria, a copper-ceria composite, a cobalt-containing cermet, a titanate-based material, a chromite-based material, or a combination thereof,
a cathode disposed on a second surface of the electrolyte opposite the first surface; wherein the cathode comprises lanthanum strontium manganite, lanthanum strontium cobalt oxide, lanthanum strontium cobalt ferrite, samarium strontium cobalt oxide, barium strontium cobalt ferrite, gadolinium-doped ceria, or a combination thereof; and
a stress compensation layer disposed on a surface of the anode or the cathode opposite the electrolyte; wherein the stress compensation layer is configured to reduce warping of the solid oxide cell during sintering or thermal cycling; wherein the electrolyte and the stress compensation layer both comprise the same material; wherein the material is yttria-stabilized zirconia, scandia-stabilized zirconia, gadolinium-doped ceria, samarium-doped ceria, lanthanum strontium magnesium gallate, stabilized bismuth oxide, a proton-conducting ceramic, or a combination thereof, and wherein the stress compensation layer and the electrolyte possess substantially identical thicknesses and are symmetrically positioned on opposing sides of the anode, the cathode or both the anode and cathode
